(19) United States
(12) Patent Application Publication
(10) Pub. No.: US 2015/0326782 A1
(43) Pub. Date: Nov. 12, 2015

(54) AROUND VIEW SYSTEM

(71) Applicant: Hyundai Mobis Co., Ltd., Seoul (KR)

(72) Inventor: Seong soo LEE, Yongin-si (KR)

(21) Appl. No.: 14/706,571

(22) Filed: May 7, 2015

(30) Foreign Application Priority Data
May 8, 2014 (KR) 10-2014-0055021

(51) Int. Cl. H04N 5/232; G01C 21/36

(52) U.S. Cl. CPC H04N 5/23238; G01C 21/3667; G01C 21/3697

(57) ABSTRACT

An around view system includes a navigation module configured to display a driving speed and a driving route of a vehicle on a navigation map, and an around view monitor (AVM) module configured to generate a panoramic image by photographing front and rear and left and right images relative to the vehicle when the driving speed falls within a predetermined threshold speed range. The AVM then transmits image control information to the navigation module so as to map the panoramic image onto the driving route.

### CROSS-REFERENCE TO RELATED APPLICATION

This application claims priority from and the benefit of Korean Patent Application No. 10-2014-0055021, filed on May 8, 2014, which is hereby incorporated by reference for all purposes as if fully set forth herein.

### BACKGROUND

1. Field

Exemplary embodiments relate to an around view system, and more particularly, to an around view system that photographs front and rear and left and right images of a vehicle while driving, generates a panoramic image using the front and rear and left and right images, and displays the generated panoramic image on a navigation map to easily serve as a black box and provide information on a driving route.

2. Discussion of the Background

An around view system that displays a top view or an around view to a driver is well known by using cameras mounted on front and rear and left and right sides of a vehicle.

The around view system displays a front image while the vehicle moves forward and a rear image while the vehicle moves rearward together with the around view image. However, the displayed front image or rear image is an image after a partial left area and a partial right area have been deleted from the photographed image.

Since left and right areas of an original image input through the camera need not be displayed, these parts of the left and right areas of the image are deleted before being displayed. However, since the around view system displays only a continuously fixed front image or rear image, when the vehicle turns in a direction towards the right or left, an image and more information cannot be provided for the corresponding direction.

In recent years, research has begun on using the around view system to photograph and store a driving route of the vehicle, which is used to help the driver view images normally not available to the driver.

The above information disclosed in this Background section is only for enhancement of understanding of the background of the inventive concept, and, therefore, it may contain information that does not form the prior art that is already known in this country to a person of ordinary skill in the art.

### SUMMARY

The disclosed exemplary embodiments have been made in an effort to provide an around view system that photographs front and rear and left and right images of a vehicle while driving, generates a panoramic image by the front and rear and left and right images, and displays the generated panoramic image on a navigation map to easily serve as a black box and provide information on a driving route.

Additional aspects will be set forth in the detailed description which follows, and, in part, will be apparent from the disclosure, or may be learned by practice of the inventive concept.

An exemplary embodiment discloses an around view system including: a navigation module configured to display a driving speed and a driving route of a vehicle on a navigation map; and an around view monitor (AVM) module configured to generate a panoramic image by photographing front and rear and left and right images relative to the vehicle when the driving speed falls within a predetermined threshold speed range and transmit image control information to the navigation module so as to map the panoramic image onto the driving route.

The navigation module may be configured to display an image shortcut menu to display the panoramic image and photographed information on the navigation map at the time of mapping the panoramic image according to the image control information.

The AVM module may include a camera module configured to photograph the front and rear and left and right images and a control module configured to synthesize the front and rear and left and right images by actuating the camera module to generate the panoramic image and transmit the image control information to the navigation module when the driving speed falls within the threshold speed range.

The camera module may be configured to photograph the front and rear and left and right images according to a photographing angle set through control by the control module.

The camera module may include a front camera configured to photograph a front side relative to the vehicle, a rear camera configured to photograph a rear side relative to the vehicle, a left camera configured to photograph a left side relative to the vehicle, and a right camera configured to photograph a right side relative to the vehicle.

The control module may include a determination unit configured to determine whether the driving speed falls within the threshold speed range, a driving unit configured to drive the camera module to perform photographing at the set photographing angle when the driving speed falls within the threshold speed range, a generation unit configured to generate the panoramic image with the front and rear and left and right images, and a control unit configured to control the image control information including the panoramic image and photographing information on the panoramic image to be generated and displayed in the navigation module.

The driving unit may be configured to drive the camera module to photograph front and rear left and right parking images at a set parking photographing angle when the driving speed does not belong to the threshold speed range.

The generation unit may be configured to generate a top-view image by synthesizing the front and rear left and right parking images.

The control unit may configured to control the front and rear and left and right parking images and the top-view image to be displayed in the navigation module at the time of generating the front and rear and left and right parking images.

The control unit may be configured to control the driving unit that drives the camera module to photograph the front and rear and left and right images for a set first time.

When a second time elapses after photographing the front and rear and left and right images and the driving speed falls within the threshold speed range, the control unit may be configured to control the driving unit to re-photograph the front and rear and left and right images.

An around view system and an operating method thereof according to exemplary embodiments generate a 360° panoramic image based on photographed front and rear and left and right images of a vehicle on a driving route of the vehicle. The panoramic image is mapped to and displayed on a navigation map to serve as a black box and be used to display images normally unavailable to a driver. As a result, driver's convenience increases based on having new information.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a control block diagram illustrating a control configuration of an around view system according to an exemplary embodiment.

FIGS. 2A, 2B, 2C, and 2D are exemplary embodiments of diagrams illustrating front and rear and left and right images of a vehicle, which are photographed in the around view system.

FIG. 3 is an exemplary embodiment of a diagram illustrating a panoramic image acquired by synthesizing the front and rear and left and right images illustrated in FIGS. 2A, 2B, 2C, and 2D.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of elements may be exaggerated for clarity and descriptive purposes. Also, like reference numerals denote like elements.

When an element is referred to as being “on,” “connected to,” or “coupled to” another element or layer, it may be directly on, connected to, or coupled to the other element or intervening elements may be present. When, however, an element is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, and/or sections, these elements, components, regions, and/or sections should not be limited by these terms. These terms are used to distinguish one element, component, region, and/or section from another element, component, region, and/or section. Thus, a first element, component, region, and/or section discussed below could be termed a second element, component, region, and/or section without departing from the teachings of the present disclosure.

Spatially relative terms, such as “front,” “back,” “left,” “right,” “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Angles and directions mentioned in describing a structure of the exemplary embodiments are based on the angles and the directions disclosed in the drawings. In describing a structure constituting a light emitting diode in the specification, when a reference point and the positional relationship for the angle are not clearly mentioned, they will be described with reference to related drawings.

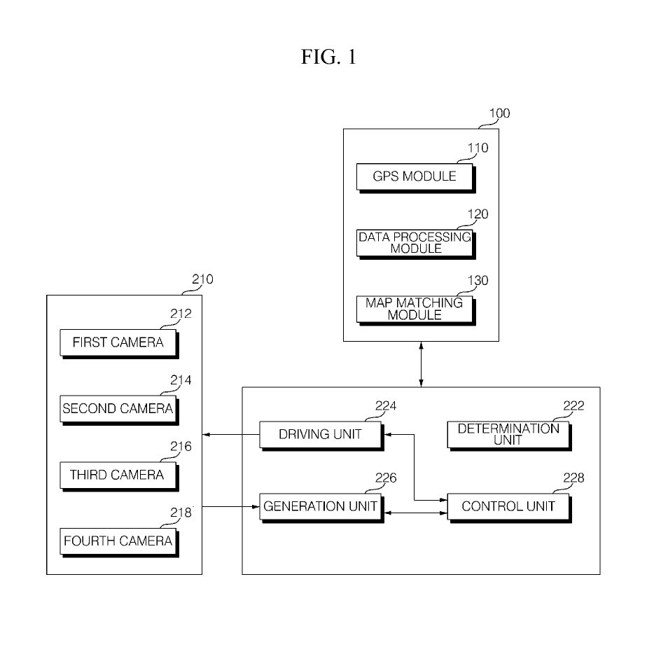

FIG. 1 is a control block diagram illustrating a control configuration of an around view system according to an exemplary embodiment.

Referring to FIG. 1, the around view system may include a navigation module 100 and an around view monitor (AVM) module 200.

The navigation module 100 stores numerical value map data including nodes having information such as a position of a road, a type of the road, and the number of traffic lanes. The navigation module 100 calculates a position thereof from positional data received from a global positioning system (hereinafter, referred to as GPS) satellites, and map-matches the calculated position thereof to the numerical value map data to display the position thereof.

The navigation module 100 may include a GPS module 110, a data processing module 120, and a map matching module 130.

The data processing module 120 processes current positional information data of the vehicle received from the GPS module 110 and data received from various vehicle sensors to output a coordinate value regarding the position of the vehicle.

Herein, various sensors are used to track a relative position of the vehicle as a movable body by using the principles of inertial navigation (dead reckoning). The vehicle or movable body sensors may be configured to include, for example, a speed sensor, a wheel sensor, an acceleration sensor, a gyro sensor, and a G-sensor.

In detail, the data processing module 120 receives a speed signal transmitted from the speed sensor, such as a pulse signal depending on a wheel rpm, to calculate a movement distance per pulse, and displays a front surface and a rear surface of the movable body by correcting a direction (heading) value of the movable body from a gyro signal and a reverse signal received from the gyro sensor to calculate the direction value.

The map matching module 130 receives a coordinate value and a relative altitude value regarding the position of the current movable body, which is output from the data processing module 120 to map-match the coordinate value and the relative altitude value to preconstructed map data, and the like.

As described above, the navigation module 100 may display map data, that is, a driving speed, the current position, and the driving route of the vehicle on the navigation map.

The AVM module 200 may include a camera module 210 and a control module 220.

The camera module 210 may include a first camera 212 photographing a front image relative to the vehicle, a second camera 214 photographing the rear image relative to the vehicle, a third camera 216 photographing the left image relative to the vehicle, and a fourth camera 218 photographing the right image relative to the vehicle.

In an exemplary embodiment, the camera module 210 includes first to fourth cameras 212, 214, 216, and 218, but may include only the second camera 214 photographing the rear image relative to the vehicle and the number of cameras is not limited.

In the exemplary embodiment, the first to fourth cameras 212, 214, 216, and 218 transfer images photographed thereby, respectively to the control module 220, which may include a camera controller (not illustrated) that generates the front and rear and the left and right images by integrating the images photographed by the first to fourth cameras 212, 214, 216, and 218 and transfers the generated images to the control module 220, but exemplary embodiments are not limited thereto.

The control module 220 may include a determination unit 222, a driving unit 224, a generation unit 226, and a control unit 228.

The determination unit 222 may determine whether the driving speed of the vehicle displayed in the navigation module 100 falls within a predetermined threshold speed range.

Herein, the determination unit 222 may repeatedly determine whether the driving speed falls within the threshold speed range when the driving speed of the vehicle does not belong to the threshold speed range.

The driving unit 224 may drive the camera module 210 according to control by the control unit 228.

That is, when within the threshold speed range, the driving unit 224 changes a predetermined parking photographing angle of the first to fourth cameras 212, 214, 216, and 218 included in the camera module 210 to a set photographing angle according to control signals from the control unit 228 to drive the front and rear and left and right images to be photographed.

Thereafter, when not within the threshold speed range, the driving unit 224 may change the photographing angle back to the parking photographing angle according to control signals from the control unit 228, but exemplary embodiments are not limited thereto.

The generation unit 226 synthesizes the front and rear and left and right images photographed by the camera module 210, that is, the first to fourth cameras 212, 214, 216, and 218, to generate a 360° panoramic image according to a predetermined synthesis method.

When not within the threshold speed range, the generation unit 226 synthesizes the front and rear and left and right images with a top-view image or an around image by the predetermined synthesis method according to the control by the control unit 228 to facilitate parking.

That is, the generation unit 226 may use homography operations on the front and rear and left and right images to find matched features and matches the front and rear and left and right images to generate the panoramic image, but exemplary embodiments are not limited thereto.

The control unit 228 drives the camera module 210 at the time when the driving speed falls within the threshold speed range while the vehicle is driven to control the driving unit 224 to photograph the front and rear and left and right images, as a result of the determination of the determination unit 222.

In this case, when the control unit 228 receives the panoramic image acquired by synthesizing the upper and lower and left and right images from the generation unit 226, the control unit 228 transmits photographed information including the time of synthesizing the panoramic image, the driving speed, and the vehicle position and image control information including the panoramic image to the display module 100.

The control unit 228 may control an image shortcut menu corresponding to the image control information to be displayed and mapped on the navigation map displayed module 100.

The control unit 228 may control the driving unit 224 that drives the camera module 210 so as to photograph the front and rear and left and right images for a set first time and when a second time elapses after photographing the front and rear and left and right images and the driving speed falls within the threshold speed range, the control unit 228 may control the driving unit 224 to re-photograph the front and rear and left and right images for the first time, but exemplary embodiments are not limited thereto.

When a driver's photographing command is input through the display module 100, the control unit 228 actuates the camera module 210 regardless of the driving speed to generate the panoramic image, but exemplary embodiments are not limited thereto.

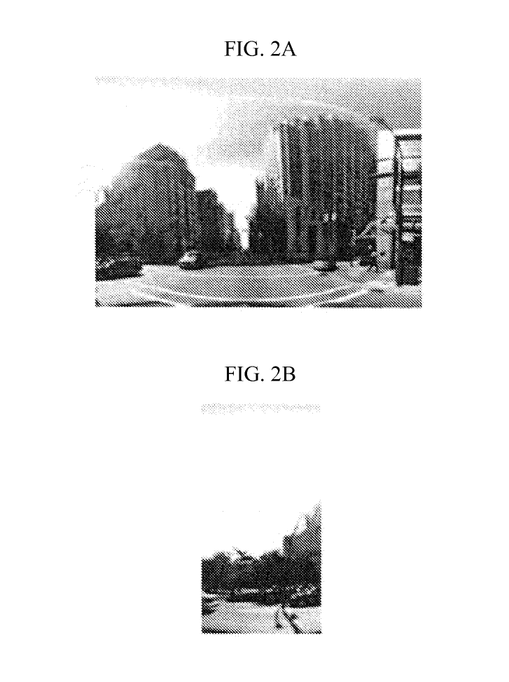

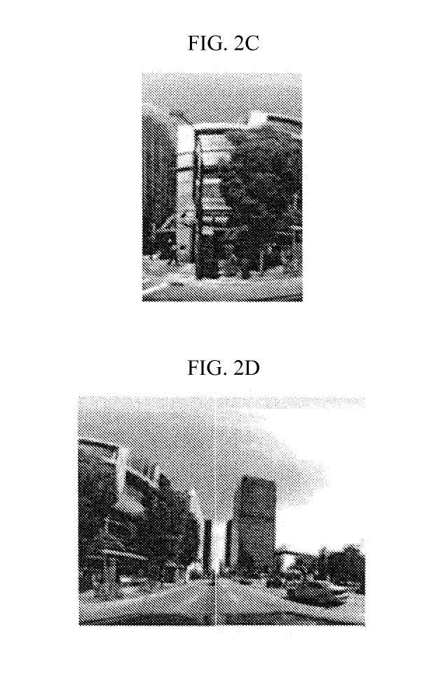

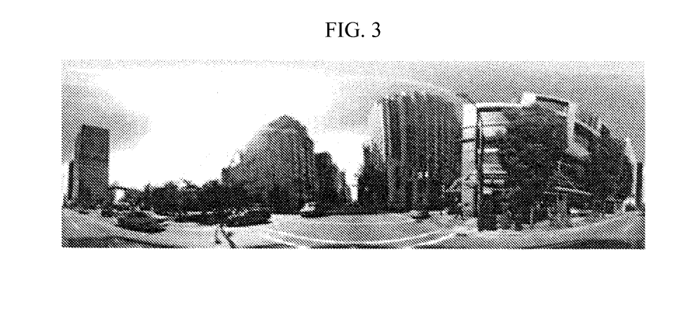

FIGS. 2A to 2D represent an exemplary embodiment of front and rear and left and right images of a vehicle, which are photographed by the around view system. FIG. 3 is an exemplary embodiment of a panoramic image acquired by synthesizing the front and rear and left and right images illustrated in FIGS. 2A to 2D.

FIG. 2A illustrates a front image photographed at a front side relative to the vehicle, that is, the first camera 212, FIG. 2B illustrates a left image photographed at a left side relative to the vehicle, that is, the third camera 216, FIG. 2C illustrates a right image photographed at a right side relative to the vehicle, that is, the fourth camera 218, and FIG. 2D illustrates a rear image photographed at a rear side relative to the vehicle, that is, the second camera 214.

FIG. 3 illustrates a panoramic image acquired by deleting duplicated parts of the front and rear and left and right images illustrated in FIGS. 2A to 2D and synthesizing the images into one image.

As described above, the panoramic image illustrated in FIG. 3 is displayed and stored in the navigation module 210, and as a result, the driver may verify the panoramic image if desired.

In exemplary embodiments, an around view system, and/or one or more components thereof, may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like.

According to exemplary embodiments, the features, functions, processes, etc., described herein may be implemented via software, hardware (e.g., general processor, digital signal processing (DSP) chip, an application specific integrated circuit (ASIC), field programmable gate arrays (FPGAs), etc.), firmware, or a combination thereof. In this manner, an around view system, and/or one or more components thereof may include or otherwise be associated with one or more memories (not shown) including code (e.g., instructions) configured to cause the around view system, and/or one or more components thereof to perform one or more of the features, functions, processes, etc., described herein.

The memories may be any medium that participates in providing code to the one or more software, hardware, and/or firmware components for execution. Such memories may be implemented in any suitable form, including, but not limited to, non-volatile media, volatile media, and transmission media. Non-volatile media include, for example, optical or magnetic disks. Volatile media include dynamic memory. Transmission media include coaxial cables, copper wire and fiber optics. Transmission media can also take the form of acoustic, optical, or electromagnetic waves. Common forms of computer-readable media include, for example, a floppy disk, a flexible disk, hard disk, magnetic tape, any other magnetic medium, a compact disk-read only memory (CD-ROM), a rewriteable compact disk (CDRW), a digital video disk (DVD), a rewriteable DVD (DVD-RW), any other optical medium, punch cards, paper tape, optical mark sheets, any other physical medium with patterns of holes or other optically recognizable indicia, a random-access memory (RAM), a programmable read only memory (PROM), and erasable programmable read only memory (EPROM), a FLASH-EPROM, any other memory chip or cartridge, a carrier wave, or any other medium from which information may be read by, for example, a controller/processor.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. An around view system comprising:
a navigation module configured to display a driving speed and a driving route of a vehicle on a navigation map; and
an around view monitor (AVM) module configured to generate a panoramic image by photographing front and rear and left and right images relative to the vehicle when the driving speed falls within a predetermined threshold speed range and transmit image control information to the navigation module so as to map the panoramic image onto the driving route.

2. The around view system of claim 1, wherein the navigation module is configured to display an image shortcut menu to display the panoramic image and photograph information on the navigation map at the time of mapping the panoramic image according to the image control information.

3. The around view system of claim 1, wherein the AVM module comprises:
a camera module configured to photograph the front and rear and left and right images; and
a control module configured to synthesize the front and rear and left and right images by actuating the camera module to generate the panoramic image and transmit the image control information to the navigation module when the driving speed falls within the threshold speed range.

4. The around view system of claim 3, wherein the camera module is configured to photograph the front and rear and left and right images according to a photographing angle set through control by the control module.

5. The around view system of claim 3, wherein the camera module comprises:
a front camera configured to photograph a front side relative to the vehicle;
a rear camera configured to photograph a rear side relative to the vehicle;
a left camera configured to photograph a left side relative to the vehicle; and
a right camera configured to photograph a right side relative to the vehicle.

6. The around view system of claim 3, wherein the control module comprises:
a determination unit configured to determine whether the driving speed falls within the threshold speed range;
a driving unit configured to drive the camera module to perform photographing at the set photographing angle when the driving speed falls within the threshold speed range;
a generation unit configured to generate the panoramic image with the front and rear and left and right images; and
a control unit configured to control the image control information including the panoramic image and photographing information on the panoramic image to be generated and displayed in the navigation module.

7. The around view system of claim 6, wherein the driving unit is configured to drive the camera module to photograph front and rear and left and right parking images at a set parking photographing angle when the driving speed does not fall within the threshold speed range.

8. The around view system of claim 7, wherein the generation unit is configured to generate a top-view image by synthesizing the front and rear and left and right parking images.

9. The around view system of claim 8, wherein the control unit is configured to control the front and rear left and right parking images to be displayed in the navigation module at the time of generating the front and rear left and right parking images.

10. The around view system of claim 5, wherein the control unit is configured to control the driving unit that drives the camera module to photograph the front and rear and left and right images for a set first time.

11. The around view system of claim 10, wherein when a second time elapses after photographing the front and rear and left and right images and the driving speed falls within the threshold speed range, the control unit is configured to control the driving unit to re-photograph the front and rear and left and right images for the first time.

12. An operating method of an around view system, the method comprising:
displaying, by a navigation module, a driving speed and a driving route of a vehicle on a navigation map;
photographing, by a plurality of cameras, front and rear and left and right images relative to the vehicle when the driving speed falls within a predetermined threshold speed range;
generating a panoramic image by synthesizing the front and rear and left and right images; and
transmitting image control information to the navigation module so as to map the panoramic image onto the driving route.

13. The method of claim 12, wherein the navigation module displays an image shortcut menu to display the panoramic image and photographing information on the navigation map at the time of mapping the panoramic image according to the image control information.

14. The method of claim 12, wherein in the generating, features match each other to generate the panoramic image based upon using homography operations on the front and rear and left and right images.
